(19) United States
(12) Patent Application Publication
(10) Pub. No.: US 2018/0291156 A1
(43) Pub. Date: Oct. 11, 2018

(54) Poly(alkylene phosphates) with reduced hygroscopicity

(71) Applicant: LANXESS Deutschland GmbH, Cologne (DE)

(72) Inventors: Heiko TEBBE, Dormagen (DE); Jan-Gerd HANSEL, Bergisch Gladbach (DE)

(73) Assignee: LANXESS Deutschland GmbH, Cologne (DE)

(21) Appl. No.: 15/946,001

(22) Filed: Apr. 5, 2018

(30) Foreign Application Priority Data
Apr. 10, 2017 (EP) 17165686.1

(51) Int. Cl. C08G 79/04; C08L 75/08; C08J 9/00; C08J 9/12; C08G 18/48; C08G 18/18; C08G 18/24; C08G 18/16; C08G 18/76

(52) U.S. Cl. CPC C08G 79/04; C08G 2101/0008; C08J 9/0061; C08J 9/125; C08G 18/48; C08G 18/1833; C08G 18/244; C08G 18/165; C08G 18/7621; C08L 2201/02; C08L 2203/14; C08J 2205/06; C08J 2375/08; C08J 2485/02; C08L 2205/025; C08L 2205/035; C08J 2203/10; C08L 75/08

(57) ABSTRACT

A mixture of poly(alkylene phosphates) having reduced hygroscopicity, includes at least three poly(alkylene phosphates) of the formula

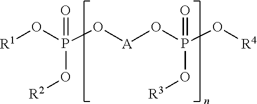

wherein R¹, R², R³ and R⁴, mutually independently, are an n-butyl moiety or a 2-methylpropyl moiety, and is usable for flame retardants, such as a flame retardant in polyurethanes.

The present invention relates to mixtures of poly(alkylene phosphates) with reduced hygroscopicity, to use of these as flame retardants, and also moreover to polyurethanes which comprise the poly(alkylene phosphates) of the invention.

### BACKGROUND INFORMATION

Poly(alkylene phosphates) can be used in various technical applications, for example as lubricants (cf. U.S. Pat. No. 2,632,767), hydraulic fluids (cf. U.S. Pat. No. 4,056,480), plasticizers (cf. U.S. Pat. No. 2,782,128) and flame retardants (cf. EP 2 687 535 B1). Poly(alkylene phosphates) provide technical advantages over comparable alkylphosphates which are likewise suitable for the applications mentioned, an example being low volatility together with low viscosity.

However, a problematic factor in these applications is that the poly(alkylene phosphates) are distinctly hygroscopic. Hygroscopicity is the property of a substance to absorb water from the water vapour in air. The water content of the poly(alkylene phosphates) thus increases uncontrollably, and this can lead to difficulties in the applications mentioned: The increased water content in hydraulic fluids can lead to the formation of vapour bubbles which can result in undesired compressibility. Flame retardants with undesired water content can cause hydrolysis of the matrix (e.g. a plastic) that is to be protected. In the case of polyurethane production, water content in the flame retardants used is always undesirable because it leads to uncontrolled foaming. Even in the case of water-blown polyurethane foams, all of the raw materials should have a minimized and constant water content in order that the properties of the foam can be controlled via precise metering of the water as blowing agent. Increased water content can generally promote corrosion of metallic materials.

Water content can moreover lead to hydrolysis of the poly(alkylene phosphates) themselves. At the same time, acidic partial esters of phosphoric acid are formed. This formation of acid is undesired in the applications mentioned, and is a hindrance to the use of the poly(alkylene phosphates).

For the abovementioned reasons, the use of poly(alkylene phosphates) is attended by protective measures which must exclude airborne moisture from the product throughout the entire product supply chain. By way of example, storage tanks require blanketing with inert gas. This makes processing more difficult and incurs increased technical cost.

EP 2 848 640 A1 describes mixtures of poly(alkylene phosphates) and phosphoric esters, the solubility of these in water at 25° C. being less than 3.0 g/l. These mixtures feature lower hygroscopicity than the poly(alkylene phosphates) present therein, and are suitable by way of example as flame retardants. These mixtures have the disadvantage that preparation thereof incurs increased cost, and that the phosphoric ester component of the mixture can have an adverse effect on advantageous properties of the pure poly(alkylene phosphates), for example low volatility.

EP-A 2 687 534 discloses mixtures of halogen-free poly(alkylene phosphates) which are suitable as halogen-free flame retardants for polyurethanes, while being amenable to processing not only with polyether polyols but also with polyester polyols, and featuring low fogging values. That document does not address the problem of the hygroscopicity of poly(alkylene phosphates).

It was therefore an object of the present invention to provide products which confer the advantages of known poly(alkylene phosphates) but which feature lower hygroscopicity and can thus be more easily processed.

### SUMMARY OF THE INVENTION

The object is achieved via mixtures of particular, selected poly(alkylene phosphates) of the general formula

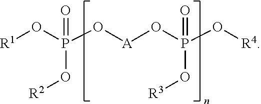

### DESCRIPTION OF THE EMBODIMENTS

In an embodiment, the mixtures of poly(alkylene phosphates) comprise at least three poly(alkylene phosphates) of the formula (I)

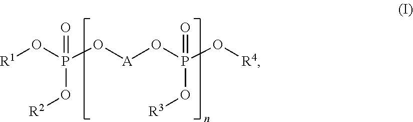

in which
R¹, R², R³ and R⁴ respectively mutually independently are an n-butyl moiety or a 2-methylpropyl moiety,
A is a moiety of the formula —CHR⁵—CHR⁶—(O—CHR⁷—CHR⁸)ₙ—,
   in which
   a is an integer from 1 to 5 and
   R¹, R⁶, R⁷ and R⁸ are mutually independently hydrogen or methyl,
      and
n is an integer from 0 to 100, preferably from 0 to 50 and particularly preferably from 0 to 30, with the proviso that at least three of the poly(alkylene phosphates) of the formula (I) present in the mixture differ from one another at least in the number n of the repeating units, and
   the weight-average value of the number of the repeating units n̅ in the poly(alkylene phosphates) of the formula (I) is in the range from 1.10 to 4.00.

It is preferable that the poly(alkylene phosphates) of the formula (I) present in the mixtures of the invention are those in which a is the number 1.

It is likewise preferable that the poly(alkylene phosphates) of the formula (I) present in the mixtures of the invention are those in which the moieties R⁵, R, R⁷ and R⁸ are all identical and are hydrogen.

It is likewise preferable that the poly(alkylene phosphates) of the formula (I) present in the mixtures of the invention are those in which the moieties R¹, R², R³ and R⁴ are all identical and are n-butyl moieties. In an alternative, likewise preferred embodiment of the invention, the moieties R¹, R², R³ and R⁴ are all identical and are 2-methylpropyl moieties.

The mixtures of the invention comprise at least three, preferably more than three, different poly(alkylene phosphates) of the general formula (I), where at least three poly(alkylene phosphates) present in the mixture differ from one another at least in the number n of the repeating units, and thus in their molar mass. The person skilled in the art uses suitable average values to describe such mixtures, examples being the number-average molar mass Mₙ and the weight-average value of the number of the repeating units n̅ in the molecules of the formula (I) present in the mixture.

It is preferable that the average value of the number of the repeating units n̅ in the poly(alkylene phosphates) of the formula (I) present in the mixtures of the invention is in the range from 1.2 to 3.0; particularly preferably in the range from 1.3 to 2.0 and very particularly preferably in the range from 1.30 to 1.90.

The number-average molar mass Mₙ of the poly(alkylene phosphates) of the formula (I) present in the mixture of the invention is determined in the case of the present invention by gel permeation chromatography with tetrahydrofuran as eluent against polystyrene standards. This method is known to the person skilled in the art, for example from DIN 55672-1:2007-08. The weight-average value of the number of the repeating units n̅ in the poly(alkylene phosphates) present in the mixture can easily be calculated (see Examples) from Mₙ, taking into account the stoichiometry of the formula (I).

Very particular preference is given to mixtures comprising at least three poly(alkylene phosphates) of the formula (I) in which
a is the number 1,
R⁵, R⁶, R⁷ and R⁸ are all identical and are hydrogen
   and
n is an integer from 0 to 100, preferably from 0 to 50 and particularly preferably from 0 to 30,
   with the proviso that at least three of the poly(alkylene phosphates) of the formula (I) present in the mixture differ from one another at least in the number n of the repeating units, and
   the weight-average value of the number of the repeating units n̅ in the poly(alkylene phosphates) of the formula (I) is in the range from 1.10 to 4.00, preferably from 1.2 to 3.0, particularly preferably from 1.3 to 2.0 and very particularly preferably from 1.30 to 1.90.

Very particular preference is likewise given to mixtures comprising at least three poly(alkylene phosphates) of the formula (I) in which
a is the number 1,
R¹, R², R³ and R⁴ are all identical and are n-butyl moieties,
R⁵, R⁶, R⁷ and R⁸ are all identical and are hydrogen,
   and
n is an integer from 0 to 100, preferably from 0 to 50 and particularly preferably from 0 to 30,
   with the proviso that at least three of the poly(alkylene phosphates) of the formula (I) present in the mixture differ from one another at least in the number n of the repeating units, and
   the weight-average value of the number of the repeating units n̅ in the poly(alkylene phosphates) of the formula (I) is in the range from 1.10 to 4.00, preferably from 1.2 to 3.0, particularly preferably from 1.3 to 2.0 and very particularly preferably from 1.30 to 1.90.

Very particular preference is likewise given to mixtures comprising at least three poly(alkylene phosphates) of the formula (I) in which
a is the number 1,
R¹, R², R³ and R⁴ are all identical and are 2-methylpropyl moieties,
R³, R⁶, R⁷ and R⁸ are all identical and are hydrogen,
   and
n is an integer from 0 to 100, preferably from 0 to 50 and particularly preferably from 0 to 30,
   with the proviso that at least three of the poly(alkylene phosphates) of the formula (I) present in the mixture differ from one another at least in the number n of the repeating units, and
   the weight-average value of the number of the repeating units n̅ in the poly(alkylene phosphates) of the formula (I) is in the range from 1.10 to 4.00, preferably from 1.2 to 3.0, particularly preferably from 1.3 to 2.0 and very particularly preferably from 1.30 to 1.90.

The mixtures of the invention can in principle be produced by alkyl-phosphate-production methods known to the person skilled in the art, for example those described in EP-A 2 687 534.

The present invention further provides a process for the production of mixtures of the invention, which is characterized in that in a first stage a dihydroxy compound of the formula (II)

HO-A-OH (II),

in which A has the general and preferred definitions stated above,
is reacted with phosphorus oxychloride POCl₃, wherein the quantity of POCl₃ used per mole of dihydroxy compound of the formula (II) is more than 1.0 mol and less than 2.0 mol and the resultant mixture of chlorophosphates of the formula (III)

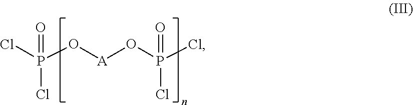

in which n is an integer from 0 to 100, preferably from 0 to 50 and particularly preferably from 0 to 30,
is reacted in a second stage with n-butanol or 2-methylpropanol or a mixture thereof.

It is preferable that the quantity of POCl₃ used per mole of dihydroxy compound of the formula (II) for the production of the mixtures of the invention is from 1.4 to 1.8 mol.

The most advantageous molar ratio, within the range stated above, of dihydroxy compounds of the formula (II) to phosphorus oxychloride POCl₃ for the production of the mixtures of the invention with an average value of the number of the repeating units n̅ in the range from 1.10 to 4.00 can easily be determined via series of experiments of the type known to the person skilled in the art.

The process of the invention can be carried out in a broad temperature range. The process of the invention is generally carried out in the temperature range from 0 to 100° C. It is preferable to operate at a temperature of from 5 to 40° C. in the first stage and generally at a temperature of from 5 to 30° C. in the second stage.

The process of the invention can be carried out in a broad pressure range. It is preferable to carry out the first stage at a pressure of from 10 to 1000 mbar and to carry out the second stage at atmospheric pressure.

It is preferable that the mixtures of the invention are materials that are liquid at about 23° C.

The dynamic viscosity of the mixtures of the invention at 23° C. is preferably from 20 to 500 mPas. The dynamic viscosity at 23° C. is particularly preferably from 30 to 200 mPas.

The mixtures of the invention are suitable for use as flame retardants and for the production of preparations that are used as flame retardants. The present invention further provides the use of the mixtures of the invention as flame retardants.

The mixtures can be used as flame retardants in any of the flame retardant applications known to the person skilled in the art. The mixtures of tbe invention are preferably used as flame retardants for
synthetic polymers, for example polyolefins, polyvinyl chloride, polycarbonates, styrene-based (co)polymers, polyamides, polyesters, polyurethanes, elastomers and thermosets such as epoxy resins, unsaturated polyester resins and phenol-formaldehyde resins,
materials of vegetable origin, for example wood, wood-plastic composites, cellulose-based materials and cellulose derivatives, paper and paperboard, and
materials of animal origin, for example leather.

It is particularly preferable to use the mixtures of the invention as flame retardants for polyurethanes. It is very particularly preferable to use the mixtures as flame retardants for polyurethane foams.

The present invention also provides preparations which are used as flame retardants. These preparations comprise, other than the mixtures of the invention, at least one auxiliary selected from the group consisting of the flame retardants differing from the oligomer mixture, antioxidants and stabilizers, polyols, catalysts and also colourants.

Examples of the flame retardants differing from the mixtures of the invention are
organophosphorus compounds, for example triethyl phosphate, triphenyl phosphate, diphenyl cresyl phosphate, tricresyl phosphate, isopropylated or butylated aryl phosphates, aromatic bisphosphates, neopentyl glycol bis(diphenyl phosphate), chlorinated phosphoric esters such as tris(chloroisopropyl) phosphate or tris(dichloropropyl) phosphate, dimethyl methanephosphonate, diethyl ethanephosphonate, dimethyl propnephosphonate, diethylphosphinic acid derivatives and the corresponding salts, other oligomeric phosphates or phosphonates, phosphorus compounds containing hydroxy groups, for example diethyl hydroxymethanephosphonate, 5,5-dimethyl-1,3,2-dioxaphosphorinane 2-oxide derivatives, 9,10-dihydro-9-oxa-10-phosphaphenanthrene 10-oxide (DOPO) and its derivatives,
inorganic phosphorus compounds, for example ammonium phosphate, ammonium polyphosphate, melamine phosphate, melamine polyphosphate,
nitrogen compounds, for example melamine, melamine cyanurate,
bromine compounds, for example alkyl esters of a tetrabromobenzoic acid, bromine-containing diols produced from tctrabromophthalic anhydride, bromine-containing polyols, bromine-containing diphenyl ethers, or
inorganic compounds, for example aluminium hydroxide, boehmite, magnesium hydroxide, expandable graphite or clay minerals.

The antioxidants and stabilizers are by way of example
sterically hindered trialkylpbenols, alkyl esters of 3-(3,5-di-tert-butyl-4-hydroxyphenyl) propionic acid, benzofuran-2-ones, secondary aromatic amines, phosphites, phenothiazines, tocopherols, or
epoxy compounds and carbodiimides.

The polyols are by way of example
polyethers, polyesters, polycarbonates or polyester amides having from 2 to 8 hydroxy groups and molar mass from 400 to 8000 g/mol, or
compounds having from 2 to 8 hydroxy groups and molar mass from 32 to 399 g/mol.

The catalysts are by way of example
amines, amidines and guanidines substituted by alkyl groups,
organotin compounds or
organophosphorus compounds.

The colourants are by way of example
soluble organic dyes,
pigments, for example organic pigments, iron oxide pigments or carbon blacks.

If the mixtures are used as flame retardants for polyurethane foams, the polyurethane foams are flexible polyurethane foams or rigid polyurethane foams. The mixtures are preferably used as flame retardants for flexible polyurethane foams which are produced from polyether polyols, i.e. flexible polyether-polyurethane foams. In an alternative, likewise preferred embodiment of the invention, the mixtures are used as flame retardants for flexible polyurethane foams which are produced from polyester polyols, i.e. flexible polyester-polyurethane foams.

The present invention moreover also provides polyurethanes which comprise the mixtures of the invention. These polyurethanes can be rendered flame-retardant via suitable selection of the quantity of mixture present.

The flame-retardant polyurethanes of the invention can be produced by reacting at least one organic 3 polyisocyanate with a polyol component comprising at least one compound having at least two hydrogen atoms reactive toward isocyanates in the presence of a mixture of the invention and optionally in the presence of conventional blowing agents, stabilizers, catalysts, activators and/or other conventional auxiliaries and additives.

The quantity used of the mixtures of the invention is from 0.5 to 30 parts by weight, preferably from 3 to 25 parts by weight, based on 100 parts by weight of polyol component.

The polyurethanes are polymers based on isocyanate and having predominantly urethane groups and/or isocyanurate groups and/or allophanate groups and/or uretdione groups and/or urea groups and/or carbodiimide groups. Production of polymers based on isocyanate is known per se and is described by way of example in DE-A publications 16 94 142, 16 94 215 and 17 20 768, and also in Kunststoff-Handbuch [Plastics handbook] Volume VII, Polyurethane [Polyurethanes], edited by G, Oertel, Carl-Hanser-Verlag, Munich, Vienna 1993.

The flame-retardant polyurethanes of the invention are thermoset polyurethanes, polyurethane foams, polyurethane clastomers, thermoplastic polyurethanes, polyurethane coatings, polyurethane lacquers, polyurethane adhesives, polyurethane binders or polyurethane fibres.

In a preferred embodiment of the invention, the flame-retardant polyurethanes of the invention are flame-retardant polyurethane foams.

Polyurethane foams are broadly divided into flexible and rigid foams. Although flexible foams and rigid foams can in principle have approximately the same density and composition, flexible polyurethane foams have only a small degree of crosslinking and exhibit only small resistance to deformation under pressure. In contrast to this, the structure of rigid polyurethane foams consists of highly crosslinked units, and rigid polyurethane foam exhibits very high resistance to deformation under pressure. The typical rigid polyurethane foam is a closed-cell foam and has a low coefficient of thermal conductivity. The main variables used to influence subsequent foam structure and foam properties during the production of polyurethanes via the reaction of polyols with isocyanates are the structure and molar mass of the polyol, and also the reactivity and number (functionality) of the hydroxy groups present in the polyol. Further details concerning rigid and flexible foams, the starting materials that can be used for production thereof, and also processes for production thereof, are found in Norbert Adam, Geza Avar, Herbert Blankenheim, Wolfgang Friederichs, Manfred Giersig, Eckehard Weigand, Michael Halfmann, Friedrich-Wilhelm Wittbecker, Donald-Richard Larimer, Udo Maier, Sven Meyer-Ahrens, Karl-Ludwig Noble and Hans-Georg Wussow: “Polyurethanes”, Ullmann's Encyclopedia of Industrial Chemistry Release 2005, Electronic Release, 7th Edn., Chapter 7 (“Foams”), Wiley-VCH, Weinheim 2005.

Densities of the polyurethane foams of the invention are preferably from 10-150 kg/m³. Their densities are particularly preferably from 20-50 kg/m³.

Starting components used for the production of the foams based on isocyanates are the following:
1) Aliphatic, cycloaliphatic, araliphatic, aromatic and heterocyclic polyisocyanates (e.g. W. Siefken in Justus Liebigs Annalen der Chemie, 562, pp. 75-136), for example those of the formula Q(NCO)ₙ, in which n=from 2 to 4, preferably from 2 to 3, and Q is an aliphatic hydrocarbon moiety having from 2 to 18 C atoms, preferably from 6 to 10 C atoms, a cycloaliphatic hydrocarbon moiety having from 4 to 15 C atoms, preferably from 5 to 10 C atoms, an aromatic hydrocarbon moiety having from 6 to 15 C atoms, preferably from 6 to 13 C atoms, or an araliphatic hydrocarbon moiety having from 8 to 15 C atoms, preferably from 8 to 13 C atoms. Particular preference is generally given to the polyisocyanates that are readily obtainable industrially, deriving from tolylene 2,4- and/or 2,6-diisocyanate or from diphenylmethane 4,4′- and/or 2,4′-diisocyanate.
2) Compounds having at least two hydrogen atoms reactive toward isocyanates and molar mass from 400 to 8000 g/mol (“polyol component”). These are not only compounds having amino groups, thio groups or carboxy groups, but also preferably compounds having hydroxy groups, in particular compounds having from 2 to 8 hydroxy groups. If the polyurethane foam is intended to be a flexible foam, it is preferable to use polyols with molar masses of from 2000 to 8000 g/mol and from 2 to 6 hydroxy groups per molecule. If, in contrast, the intention is to produce a rigid foam, it is preferable to use highly branched polyols with molar masses of 400 to 1000 g/mol and from 2 to 8 hydroxy groups per molecule. The polyols are polyethers and polyesters, and also polycarbonates and polyester amides, these being of the type known per se for the production of homogeneous and cellular polyurethanes and as described by way of example in German Offenlegungsschrift 28 32 253. Preference is given in the invention to the polyethers and polyesters having at least two hydroxy groups.

The polyurethane foams of the present invention can thus be produced as rigid or flexible foams by appropriate selection of the starting materials in the manner that can easily be found in the prior art.

Other starting components are optionally compounds having at least two hydrogen atoms reactive toward isocyanates and molar mass from 32 to 399 g/mol. In this case too, these are compounds having hydroxy groups and/or amino groups and/or thio groups and/or carboxy groups, preferably compounds having hydroxy groups and/or amino groups, serving as chain extenders or crosslinking agents. These compounds generally have from 2 to 8 hydrogen atoms reactive toward isocyanates, preferably from 2 to 4. Examples here are likewise described in DE-A publication 28 32 253.
3) Water and/or volatile organic substances as blowing agent, e.g. n-pentane, isopentane, cyclopentane, acetone, halogen-containing alkanes, for example trichloromethane, methylene chloride or chlorofluoroalkanes, CO₂ and others.
4) Auxiliaries and additives are optionally used concomitantly, examples being catalysts of the type known per se, surface-active additives, for example emulsifiers and foam stabilizers, reaction retarders, e.g. substances having acidic reaction, for example hydrochloric acid or organic acyl halides, and also cell regulators of the type known per se, for example paraffins or fatty alcohols and dimethylpolysiloxanes, and also pigments or dyes and further flame retardants, and also stabilizers in respect of ageing effects and weathering effects, scorch inhibitors, plasticizers and fungistatic and bacteriostatic substances, and also fillers, for example barium sulfate, kieselguhr, carbon black or precipitated chalk (DE-A publication 27 32 292). Particular scorch inhibitors that can be present are sterically hindered trialkylphenols, alkyl esters of 3-(3,5-di-tert-butyl-4-hydroxyphenyl)propionic acid, benzofuran-2-ones, secondary aromatic amines, phosphites, phenothiazines or tocopherols.

The following compounds can also be present as further flame retardants alongside the mixtures of the invention in the polyurethanes of the invention:
organophosphorus compounds, for example triethyl phosphate, triphenyl phosphate, diphenyl cresyl phosphate, tricresyl phosphate, isopropylated or butylated aryl phosphates, aromatic bisphosphates, neopentyl glycol bis(diphenyl phosphate), chlorinated phosphoric esters such as tris(chloroisopropyl) phosphate or tris(dichloropropyl) phosphate, dimethyl methanephosphonate, diethyl ethanephosphonate, dimethyl propanephosphonate, diethylphosphinic acid derivatives and the corresponding salts, other oligomeric phosphates or phosphonates, phosphorus compounds containing hydroxy groups, for example diethyl hydroxymethanephosphonate, 5,5-dimethyl-1,3,2-dioxaphosphorinane 2-oxide derivatives, 9,10-dihydro-9-oxa-10-phosphaphenanthrene 10-oxide (DOPO) and its derivatives,
inorganic phosphorus compounds, for example ammonium phosphate, ammonium polyphosphate, melamine phosphate, melamine polyphosphate,
nitrogen compounds, for example melamine, melamine cyanurate,
bromine compounds, for example alkyl esters of a tetrabromobenzoic acid, bromine-containing diols produced from tetrabromophthalic anhydride, bromine-containing polyols, bromine-containing diphenyl ethers,
inorganic flame retardants, for example aluminium hydroxide, boehmite, magnesium hydroxide, expandable graphite or clay minerals.

Other examples of surface-active additives and foam stabilizers that can optionally be used concomitantly according to the invention, and also cell regulators, reaction retarders, stabilizers, flame-retardant substances, plasticizers, dyes and fillers, and also fungistatic and bacteriostatic substances, and also details concerning the mode of use and mode of action of these additives, are described in Kunststoff-Handbuch [Plastics handbook], Volume VII, Carl-Hanser Verlag, Munich, 1993, on pages 104 to 123.

The present invention further provides a process for the production of polyurethanes via reaction of organic polyisocyanates with a polyol component comprising at least one compound having at least 2 hydrogen atoms reactive toward isocyanates and with conventional blowing agents, stabilizers, catalysts, activators and/or other conventional auxiliaries and additives at from 20 to 80° C., which uses a quantity of from 0.5 to 30 parts by weight, based on 100 parts by weight of polyol component, of at least one mixture of the invention. It is preferable to use a quantity of from 3 to 25 parts by weight of the mixtures, based on 100 parts by weight of polyol component.

The process for the production of polyurethanes of the invention is carried out by reacting the reaction components described above in the single-stage process known per se, the prepolymer process or the semiprepolymer process, often with use of machinery such as that described in U.S. Pat. No. 2,764,565. Details concerning processing equipment which can also be used according to the invention are described in Kunststoff-Handbuch [Plastics Handbook], Volume VII, Polyurethane [Polyurethanes], edited by G. Oertel, Carl-Hanser-Vedag, Munich, Vienna, 1993, on pages 139 to 192.

The process of the invention can also be used to produce cold-curing foams (GB Patent Specification 11 62 517, DE-A publication 21 53 086). However, it is also possible, of course, to produce foams via block foaming or by the twin-conveyor-belt process known per se. Polyisocyanurate foams are produced by the processes, and under the conditions, known for this purpose.

The process of the invention permits production of polyurethane foams as rigid or flexible foams in a continuous or batch procedure or as foamed mouldings. Preference is given to the process of the invention in the production of flexible foams produced by a block foaming process.

The polyurethanes obtainable according to the invention are preferably employed in furniture cushioning, textile inserts, mattresses, vehicle seats, armrests, components, seat and instrument panel trim, cable sheathing, seals, coatings, paints, adhesives, adhesion promoters and fibres.

The preparations of the invention comprising the mixtures of the invention can be produced by known methods from known components. The preparations of the invention are liquid and have good metering properties and are therefore very easy to process. The reduced hygroscopicity reduces the risk of undesired contamination with water during contact with air.

The invention is explained in more detail with reference to the examples below, without any intention that these restrict the invention.

### EXAMPLES

### Production Examples

### General Synthesis Specification for the Mixtures of the Invention (Synthesis Examples S1 to S5)

The quantity (parts by weight) stated in Table 1 of phosphorus oxychloride was charged to a reactor with stirrer, dropping funnel, reflux condenser and vacuum equipment. The temperature of the phosphorus oxychloride was controlled from 10 to 20° C. The quantity stated in Table 1 of diethylene glycol was added dropwise under a vacuum range from 500 to 700 mbar. On completion of the dropwise addition the pressure was reduced further to a final pressure of from 5 to 15 mbar and the temperature was raised to from 20 to 30° C. The residue was a virtually colourless liquid.

The quantity stated in Table 1 of 2-methylpropanol and, respectively, n-butanol was charged in a further reactor with stirrer, dropping funnel and reflux condenser at 20 to 30′C, and the residue obtained above was admixed therewith. Stirring of the mixture was continued at a temperature in the range from 20 to 30° C. until the reaction ended, and the mixture was then neutralized by adding aqueous sodium hydroxide. The result was two clear liquid phases. These were separated, and the organic phase was freed from excess reagent by distillation. The distillation residue was washed with water, and residual water was finally removed by distillation.

The residue was the mixture of the invention in the form of colourless liquid. The viscosities of the resultant products were determined at 23° C. with a commercially available falling-ball viscometer, and are listed in Table 1.

### Synthesis Specification for the Non-Inventive Comparative Substance According to EP-A 2 687 534 (Synthesis Example CompS1)

The quantity (parts by weight) stated in Table 1 of phosphorus oxychloride was charged to a reactor with stirrer, dropping funnel, reflux condenser and vacuum equipment. The temperature of the phosphorus oxychloride was controlled from 10 to 20° C. The quantity stated in Table 1 of diethylene glycol was added dropwise under a vacuum range from 500 to 700 mbar. On completion of the dropwise addition the pressure was reduced further to a final pressure of from 5 to 15 mbar and the temperature was raised to from 20 to 30° C. The residue was a virtually colourless liquid. The quantity stated in Table 1 of ethanol was charged in a further reactor with stirrer, dropping funnel and reflux condenser at a temperature in the range from 20 to 30° C., and the residue obtained above was admixed therewith. Stirring of the mixture was continued from 20 to 30° C. until the reaction ended, and the mixture was then neutralized by adding concentrated aqueous sodium hydroxide. Dichloromethane and water were then added in quantities sufficient to produce two clear liquid phases. These were separated, and the organic phase was freed from dichloromethane, excess ethanol and water by distillation. The residue was the non-inventive oligomer in the form of a colourless liquid. The viscosity of the resultant product was determined at 23° C. with a commercially available falling-ball viscosimeter, and is listed in Table 1.

### Determination of the Weight-Average Value of the Number of the Repeating Units n̅ in the Mixtures S1 to S5 and CompS1

Analysis by gel permeation chromatography (GPC) showed that the products produced in the Synthesis Examples S1 to S5 and compS1 were mixtures. The number-average molar masses Mₙ of the mixtures were determined by GPC with tetrahydrofuran as eluent against polystyrene standards based on the method of DIN 55672-1:2007-08. The weight-average value of the number of the repeating units n̅ in the poly(alkylene phosphates) corresponding to the formula (I) present in the mixture was calculated from the measured number-average molar mass Mₙ by the following formula:

n̅=(Mₙ−M_{R})/M_{R}

where
n̅: weight-average value of the number of the repeating units in the poly(alkylene phosphates) of the formula (I) present in the mixture,
Mₙ: number-average molar mass in g/mol determined by gel permeation chromatography.
M_{E}: sum of the molar masses of the terminal groups in g/mol and
M_{R}: molar mass of the repeating unit in g/mol.

For the mixtures S1 to S5 of poly(alkylene phosphates) of the formula (I) where R¹=R²=R³=R⁴=n-butyl or 2-methylpropyl and A=—CH₂CH₂OCH₂CH₂—, M_{R}=266.31 g/mol and M_{R}=224.19 g/mol. For the non-inventive comparative substance compS1 of poly(alkylene phosphates) of the formula (I) where R¹=R²=R³=R⁴ ethyl and A=CH₂CH₂OCH₂CH₂—, M_{E}=182.16 g/mol and M_{R}=194.14 g/mol. The results are listed in Table 1.

TABLE 1
Raw materials used (parts by weight) for the production of the
mixtures of the invention (Synthesis Examples S1 to S5) and of
the non-inventive comparative substance compS1, and
properties thereof

| | Example | | | | | |
|---|---|---|---|---|---|---|
| | S1 | S2 | S3 | S4 | S5 | compS1 |
| Phosphorus oxychloride | 149.6 | 182.8 | 154.1 | 151.7 | 154.1 | 306.7 |
| Diethylene glycol | 74.0 | 68.3 | 62.7 | 66.3 | 62.7 | 118.7 |
| 2-Methylpropanol | 380.0 | 500.0 | 444.7 | 360.0 | | |
| n-Butanol | | | | | 444.7 | |
| Ethanol | | | | | | 618.2 |
| Viscosity [mPas] | 315 | 79 | 97 | 138 | 93 | 58 |
| Mn [g/mol] | 844 | 608 | 656 | 709 | 649 | 462 |
| n̅ | 2.58 | 1.53 | 1.74 | 1.97 | 1.71 | 1.44 |

### Determination of Water Absorption

The experiments used the mixture S3 of the invention and the comparative substance compS1. Water absorption was determined by in each case charging 100 ml of the test mixture to a 250 ml glass beaker (height 12 cm, diameter 6 cm) and storing same, uncovered, in a cabinet under controlled conditions of temperature and humidity for seven days (23° C. and 50% relative humidity). The water content of the mixtures was determined by Karl-Fischer titration in accordance with DIN 51777. Before the water determination, the samples were in each case homogenized by stirring. The results are listed in Table 2.

TABLE 2
Water absorption of the mixture S3 of the invention and of the non-
inventive comparative substance compS1

| | Water absorption after storage for |
|---|---|
| Substance | seven days [% by weight] |
| S3 | 0.75 |
| VS1 | 1.50 |

### Evaluation of the Water Absorption Results

According to the results listed in Table 2, the non-inventive comparative substance compS1 exhibits considerable water absorption under the test conditions. In the absence of complicated precautions, the product rapidly absorbs a quantity of water that can be problematic in technical applications. The mixture S3 of the invention exhibits markedly lower water absorption than the comparative substance compS1. It therefore features lower hygroscopicity, and this represents an advantage in water-sensitive technical applications.

### Determination of Resistance to Hydrolysis

The acid number of the mixture S3 of the invention and of the comparative example compS1 was determined by titration with 0.1 molar aqueous sodium hydroxide. Samples of the two substances were then mixed with 10% by weight of tap water, and the mixture was stored at 60° C. for a week. The acid number was then determined by titration as above. The results are listed in Table 3.

TABLE 3
Resistance to hydrolysis of the mixture S3 of the invention and of the non-
inventive comparative substance compS1

| | | | Increase of acid |
|---|---|---|---|
| | Acid number before | Acid number after | number |
| Substance | storage [mg KOH/g] | storage [mg KOH/g] | [mg KOH/g] |
| S3 | 0.18 | 0.19 | 0.01 |
| VS1 | 0.51 | 0.81 | 0.30 |

### Evaluation of the Results for Resistance to Hydrolysis

According to the results listed in Table 3, storage of the substances in the presence of water leads to an increased acid number. This increase is attributable to partial hydrolysis of the trialkyl phosphates, forming the corresponding alcohols and acidic partial esters of phosphoric acid. The quantity of acid formed increases with the extent of hydrolysis.

The acid number of the non-inventive comparative substance compS1 increases significantly by 0.30 mg KOH/g. In contrast, only a minimal increase of 0.01 mg KOH/g is recorded for the mixture S3 of the invention. The mixture S3 of the invention therefore exhibits greater resistance to hydrolysis than the comparative substance compS1 under identical test conditions.

The combination of lower hygroscopicity and greater resistance to hydrolysis renders the mixtures of the invention less susceptible to the detrimental effect of contact with atmospheric moisture. Poly(alkylene phosphates) have exposure to atmospheric moisture in various technical applications, and it therefore becomes easier to use these by way of example as lubricants, hydraulic fluids, plasticizers or flame retardants.

### Production of Flexible Polyurethane Foams

TABLE 4
Raw materials used for production of flexible polyether-polyurethane foams

| Component | Function | Description |
|---|---|---|
| A | Polyol | Arcol ® 1105 (Covestro AG), |
| | | polyether polyol with OHN 56 mg KOH/g |
| B | Blowing agent | Water |
| C | Catalyst | Addocat 108 ® (LANXESS Deutschland GmbH), 70% |
| | | solution of bis(2-dimethylaminoethyl) ether in dipropylene |
| | | glycol |
| D | Catalyst | Addocat ® SO (LANXESS Deutschland GmbH), tin(II) 2- |
| | | ethylhexanoate |
| E | Stabilizer | Tegostab ® B 8232 (Degussa), silicone stabilizer |
| F | Flame retardant | F1: Comparative substance compS1 |
| | | F2: mixture S4 of the invention |
| G | Diisocyanate | Desmodur ® T 80 (Covestro AG), |
| | | Tolylene diisocyanate, isomer mixture |

### Production of Flexible Polyether-Polyurethane Foams

The raw materials for production of flexible polyether-polyurethane foams are stated in Table 4. The components stated in terms of type and quantity in Table 5, with the exception of the diisocyanate (component G), were mixed to give a homogeneous mixture. The diisocyanate was then added, and incorporated by brief vigorous stirring. The density of the flexible polyether-polyurethane foam obtained after a cream time of from 15 to 20 seconds and a full-rise time of from 160 to 180 seconds was 33 kg/m. Uniformly fine-pore foams were obtained in all of the experiments.

### Determination of Flame Retardancy

The flexible polyurethane foams were tested in accordance with the specifications in Federal Motor Vehicle Safety Standards FMVSS 302 and classified in accordance with the flammability ratings SE (self-extinguishing), SE/NBR (self-extinguishing/no burn rate), SE/BR (self-extinguishing/with burn rate), BR (burn rate) und RB (rapid burn). The fire tests were carried out five times for each Example. The poorest result from each series of five has been shown in Table 5.

TABLE 5
Composition (parts by weight) and test results for the Example V3 of the
invention and the non-inventive Comparative Examples V1 and V2
relating to flexible polyether-polyurethane foams

| | Example | | |
|---|---|---|---|
| | V1 | V2 | V3 |
| A | 100 | 100 | 100 |
| B | 3.0 | 3.0 | 3.0 |
| C | 0.08 | 0.08 | 0.08 |
| D | 0.16 | 0.16 | 0.16 |
| E | 1.00 | 1.00 | 1.00 |
| F1 | | 4 | |
| F2 | | | 8 |
| G | 40.9 | 40.9 | 40.9 |
| MVSS rating | RB | SE | SE |

### Evaluation of Results Relating to Flexible Polyether-Polyurethane Foams

In the absence of a flame retardant (Example V1), the flexible polyurethane foam is rapidly consumed by combustion (MVSS flammability rating RB). Both the foam of Example V2, with the non-inventive flame retardant F1, and the foam of Example V3, with the flame retardant F2 of the invention, achieve the best MVSS fire rating SE (self-extinguishing).

### CONCLUSION

As is apparent from the results in Tables 2 and 3, the mixtures of the invention surprisingly feature lower hygroscopicity together with increased resistance to hydrolysis. The overall effect of the above is that the mixtures of the invention are less susceptible to the detrimental effect of contact with atmospheric moisture. Water content in the flame retardants used in particular in polyurethane production is always undesirable, because it leads to uncontrolled foaming. The reduced hygroscopicity of the mixtures of the invention therefore represents a great technical advantage. The flame-retardant effect in polyurethane foams of the mixtures of the invention, with their improved hygroscopicity, is moreover excellent and equal to that of the flame retardants known from the prior art, as can be seen from Table 5.

What is claimed is:

1. A poly(alkylene phosphate) mixture having reduced hygroscopicity and greater resistance to hydrolysis, the mixture comprising at least three poly(alkylene phosphates) of the formula (I) 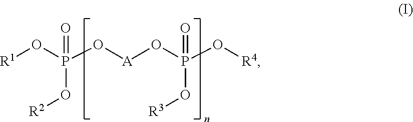
in which
R¹, R², R³ and R⁴, mutually independently, are an n-butyl moiety or a 2-methylpropyl moiety,
A is a moiety of the formula —CHR⁵—CHR⁶—(O—CHR⁷—CHR⁸)ₙ—,
in which
a is an integer from 1 to 5, and
R⁵, R⁶, R⁷ and R⁸ are, mutually independently, hydrogen or methyl, and
n is 0 to 100,
wherein at least three of the poly(alkylene phosphates) of the formula (I) differ from one another at least in the number n of repeating units, and
a weight-average value n̅ of the number n of the repeating units is 1.10 to 4.00.

2. The mixture according to claim 1, wherein a is 1.

3. The mixture according to claim 1, wherein R⁵, R⁶, R⁷ and R⁸ are each hydrogen.

4. The mixture according to claim 1, wherein R¹, R², R³ and R⁴ are each an n-butyl moiety.

5. The mixture according to claim 1, wherein R¹, R², R⁴ and R are each a 2-methylpropyl moiety.

6. The mixture according to claim 1, wherein the weight-average value n̅ is 1.2 to 3.0.

7. The mixture according to claim 1, wherein the mixture has a dynamic viscosity of 20 to 500 mPas at 23° C.

8. The mixture according to claim 1, wherein:
n is 0 to 50,
the weight-average value n̅ is 1.3 to 2.0, and
the mixture has reduced hygroscopicity compared to a compound of the formula (I) wherein R¹, R², R³ and R⁴ are ethyl moieties.

9. The mixture according to claim 1, wherein:
R¹, R², R³ and R⁴ are each a 2-methylpropyl moiety,
R⁵, R⁶, R⁷ and R⁸ are each hydrogen,
n is 0 to 30, and
the weight-average value n̅ is 1.30 to 1.90.

10. A process for the production of the mixture according to claim 1, the process comprising:
contacting a dihydroxy compound of the formula (II)
HO-A-OH (II),
in which A is as defined in claim 1,
with phosphorus oxychloride POCl₃,
wherein the quantity of POCl₃ used per mole of dihydroxy compound of the formula (II) is more than 1.0 mol and less than 2.0 mol,
to produce a resultant mixture of chlorophosphates of the formula (III) 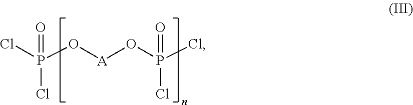
in which n is an integer from 0 to 100, and A is as defined in claim 1, and
contacting the resultant mixture of chlorophosphates of the formula (III) with n-butanol or 2-methylpropanol or a mixture thereof to produce the mixture according to claim 1.

11. A preparation comprising a mixture according to claim 1 and at least one other component selected from the group consisting of:
a) flame retardants differing from the mixture of the invention,
b) antioxidants and stabilizers,
c) polyols,
d) catalysts and
e) colourants.

12. A flame retardant comprising:
the mixture according to claim 1, or
a preparation comprising the mixture according to claim 1 and at least one other component selected from the group consisting of:
a) flame retardants differing from the mixture of claim 1,
b) antioxidants and stabilizers,
c) polyols,
d) catalysts and
e) colourants.

13. A flame-retardant polyurethane comprising the mixture according to claim 1.

14. The flame retardant polyurethane according to claim 13, further comprising at least one other component selected from the group consisting of:
a) flame retardants differing from the mixture of claim 1,
b) antioxidants and stabilizers,
c) polyols,
d) catalysts and
e) colourants.

15. The flame-retardant polyurethane according to claim 13, wherein the polyurethane is a polyurethane foam.

16. The flame-retardant polyurethane according to claim 15, wherein the foam is based on polyether polyols or on polyester polyols.

17. A process for the production of the flame-retardant polyurethane according to claim 13, the process comprising contacting at least one organic polyisocyanate with a polyol component comprising at least one compound having at least two hydrogen atoms reactive toward isocyanates, in the presence of the mixture according to claim 1, and optionally in the presence of conventional blowing agents, stabilizers, catalysts, activators and/or other conventional auxiliaries and additives at a temperature of 20 to 80° C.

18. An article of manufacture comprising the flame-retardant polyurethane according to claim 13.

19. The article of manufacture according to claim 18, wherein the article of manufacture is one of furniture cushioning, textile inserts, mattresses, vehicle seats, armrests, components, seat trim, instrument panel trim, cable sheathing, seals, coatings, paints, adhesives, adhesion promoters and fibres.
